(19) United States
(12) Patent Application Publication
(10) Pub. No.: US 2016/0057462 A1
(43) Pub. Date: Feb. 25, 2016

(54) DISTRIBUTION OF ASSETS FOR DIFFERENT MOVIE VERSIONS

(71) Applicant: THOMSON LICENSING, Issy les Moulineaux (FR)

(72) Inventors: Nicholas Curtis MITCHELL, Los Angeles, CA (US); William Gibbens REDMANN, Glendale, CA (US)

(73) Assignee: Thomson Licensing, Issy de Moulineaux (FR)

(21) Appl. No.: 14/780,891

(22) PCT Filed: Apr. 9, 2014
(86) PCT No.: PCT/US2014/033502

§ 371 Date: Sep. 28, 2015

Related U.S. Application Data
(60) Provisional application No. 61/818,911, filed on May 2, 2013.

(51) Int. Cl. H04N 21/2343; H04N 21/485; H04N 21/854

(52) U.S. Cl. CPC H04N 21/23439; H04N 21/85406; H04N 21/4856

(57) ABSTRACT

A method and system are disclosed for distributing different versions of a movie. A digital cinema package contains assets for different versions of the movie and a first composition playlist representing a first version of the movie. A second composition playlist, which represents a second version of the movie, is available separately from the first digital cinema package. At least one picture track file in the digital cinema package has a portion that is not referenced by the first composition playlist, but referenced by the second composition playlist.

This application claims the benefit of U.S. Provisional Application No. 61/818,911 filed May 2, 2013 and is incorporated herein.

### TECHNICAL FIELD

Embodiments of the present invention relate to a method and system for distributing digital cinema compositions for multiple versions of the same movie.

### BACKGROUND

Presently, when a movie is to be distributed to a digital cinema theatre for exhibition, a digital cinema package (DCP) is created. The DCP includes asset track files for the picture (picture track files), the sound (sound track files), and other assets (e.g., subtitles, closed captions). The DCP also includes another file, a composition play list (CPL), which describes how to assemble specific asset track files for playout to render the specific version of the movie represented by the CPL. The CPL organizes the composition as a series of one or more reels, each reel referring to one each of a sound and picture track file, and in some cases other kinds of asset track files, some of which are mentioned below. This collection of track files and the CPL file are listed in a packing list file (PKL), which provides an inventory of the files provided in this DCP. One final file, not listed in the PKL, is an asset map, which provides a convenient index for translating between the names of all these files (the track files, CPL, and PKL) and Universal Unique Identifiers (UUID), which these files use to reference each other. This is important because the names of the files are not required to persist once a composition is ingested into a screen server for playout, but the UUIDs are expected to persist. This configuration of a digital cinema package is well known, and a particular version has been standardized by the Society of Motion Picture and Television Engineers (SMPTE), of White Plains, N.Y., as documented in their series of standards, in particular the ST 429 D-Cinema Packaging family of standards. Additionally, another DCP format functioning in a substantially similar way to that standardized by SMPTE, was prescribed by Digital Cinema Initiatives, LLC, of Hollywood, Calif., and is known as the Interop package and is currently the most widely used digital cinema packaging format.

A DCP can be prepared to include more than one version of a movie. When a second version of the movie is required, for example one that includes subtitles in a foreign language (i.e., a language other than in which most of the dialog is spoken), a subtitle track file is added to the DCP (appropriate inventoried by the PKL and indexed by the asset map), as is a new, additional CPL that describes how to assemble not only the original asset track files, but also the subtitle track file. When the DCP is presented to digital cinema equipment in an exhibition theatre, the two CPLs are identified to the projectionist who is then able to select which of the two CPLs (each corresponding to a different version of the movie) to ingest. The projectionist can choose whichever of the CPLs is suitable.

In some situations, the two movie versions are shipped as separate DCPs, and the standards describe how this can be done.

One well-known approach is to make two self-contained DCPs, each with the complete set of asset track files necessary to play out the corresponding version of the movie. A problem with this approach is that there is an enormous amount of duplication of data (e.g., the picture track files which may amount to hundreds of gigabytes), which are difficult and expensive to transport. Communicating these two DCPs to a theatre is roughly twice as expensive as communicating just one.

The picture track files are considered “heavy assets”, since a large amount of data is necessary to present digital cinema quality images at typical frame rates. Subtitles, which includes the text that the audience will be reading, plus some metadata for their placement on the screen (e.g., where and when), are considered “light assets” because of the relatively small amount of data. Even in cases where subtitles are provided as images, and there might be several hundred subtitles in a movie (versus 144,000 frames in a 100-minute movie at 24 frames per second) subtitles are still considered “lightweight” compared to picture track files. Sound track files are in between, but still much smaller than picture track files.

Another well-known approach of movie distribution eliminates the duplication of assets. The DCP for the first version is created and can be distributed as an “original version” or “OV”. A DCP for the second version can be created, called a “supplemental” package, in which the packing list identifies all the components as before, but the duplicative assets are not listed in the asset map, nor included in the supplemental DCP. Thus, the supplemental package would include a second CPL, the subtitle track file, a PKL that refers to these files and the assets in the OV package, and an asset map that indexes only the second CPL and the PKL. In this arrangement, the first DCP (the OV) is substantially unchanged, but the second DCP (the supplemental package) is comparatively small, e.g., about 1 MB, such that it can be easily emailed or otherwise transmitted with great speed and economy.

A difficulty arises, however, if the second version of the movie includes a change to the picture assets. This commonly occurs when a movie to be distributed internationally includes additional credits that are not included in the original version. The prior art distribution approach would put the new picture assets (e.g., those corresponding to additional credits) into the supplemental package as an additional picture assets file, which would be accompanied by corresponding sound assets and referenced by the second CPL, as a new reel. However, this makes the supplemental package substantially larger (e.g., on the order of 5-10 GB) and many different supplemental packages may be needed, for example for each different language in which the movie is to be subtitled, again greatly increasing the expense of distributing these additional versions of the movie.

Although an alternative workaround procedure is available, it is not completely reliable. In this workaround, the additional assets (e.g., the additional picture assets representing the new credits) are included in the OV, but not referenced by the first CPL. The PKL of this slightly larger DCP identifies the new asset file(s), even though the first CPL does not use them. Then, the supplemental package need only include the second CPL, the subtitle asset file, and the corresponding second PKL and second asset map. This second PKL lists the additional assets accompanying the second CPL, and the second asset map provides the index of which files correspond. The expectation is that, upon ingest, all the assets of the original DCP are loaded into the digital cinema equipment. Subsequently, when the supplemental package is presented to the digital cinema equipment, the second CPL and the new assets (if any) are loaded, after which all of the required assets are present for the second CPL to playout.

Unfortunately, this procedure does not work reliably. Digital cinema systems are not required to ingest the entirety of a package, and some systems choose to optimize load times by ingesting only the assets necessary for a selected CPL. Under such an optimization, the extra asset files in the first DCP (e.g., those corresponding to the additional credits) will not have been ingested. When a supplemental package arrives later and is presented to the system, some of the necessary assets are not available, and often the projectionist no longer has access to them (e.g., if the distribution drive on which the original version DCP was shipped has been returned, or if the unused assets have been purged from the local library server).

This problem is further compounded by what are called “side-to-side” transfers, in which a first digital cinema equipment (e.g., in a first auditorium) is used as the source for a movie to be ingested by a second digital cinema equipment (e.g., in a second, nearby, auditorium). Typically, the projectionist identifies the desired CPL, which, along with the required assets, are transferred from the first equipment to the second equipment. Such a scenario might actually occur during an “emergency transfer” in which the movie is being shown as the movie is being transferred. After the emergency transfer, the transferred version of the movie remains available on the second equipment for subsequent playout. However, even if the first equipment had ingested all of the assets of the original version DCP (including the ones not required by the first CPL), they would not have transferred during the side-to-side transfer process. Thus, the second equipment will not have even been presented with the assets necessary for playing out the second CPL in the supplemental package.

Thus, a need exists for a method of preparing digital cinema packages for multiple versions of the same movie, so that certain assets are assured to be ingested and retained by digital cinema equipment so as to be available when a supplemental package for a different version of the same movie is provided.

### SUMMARY OF THE INVENTION

One aspect of the present principles provides a method for creating and distributing two versions of a movie. A first digital cinema package, the original version, contains all of the assets for a first composition playlist, in which at least one of those assets is an asset of relatively large size, such as a picture asset, or other large asset, e.g., sound or audio assets, which is not referenced by the first composition playlist (e.g., not used in playout of the first composition playlist). The first digital cinema package, including the first composition playlist, is created and distributed. A second composition playlist is created, referencing the unused assets in the first digital cinema package. This second composition playlist may be distributed separately, and since this composition playlist has a file size that is significantly or orders of magnitude smaller than that of a picture asset, this distribution can be fast and economical. In some cases, the second composition playlist is provided in a second digital cinema package. The second digital cinema package may further include additional assets, e.g., subtitle track files and/or alternative sound track files, as needed for the second version and not provided in the first digital cinema package.

One embodiment provides a method for movie distribution, which includes: a) distributing a first digital cinema package comprising a first composition packing list (CPL) and a picture track file; the picture track file having a first portion and a distinct second portion corresponding to respective first and second picture assets that are associated with respective first and second versions of a movie; wherein the first CPL references the first portion but not the second portion of the picture track file; and b) distributing a second CPL without the second picture asset, wherein the second CPL references at least the second portion of the picture track file; wherein the first CPL corresponds to a first version of the movie, and the second CPL corresponds to the second version of the movie.

Another embodiment provides a digital cinema distribution, which comprises: a first digital cinema package that includes: a first picture track file having a first portion corresponding to a first picture asset and a distinct second portion corresponding to a second picture asset, wherein the first picture asset is associated with a first version of a movie and the second picture asset is associated with a second version of the movie; and a first composition packing list (CPL) that references the first portion of the first picture track file but not the second portion. The digital cinema distribution further comprises a second CPL that references at least the second portion of the first picture track file, wherein the second CPL does not include the second picture asset; and wherein the first CPL corresponds to a first version of the movie, and the second CPL corresponds to the second version of the movie.

### BRIEF DESCRIPTION OF THE DRAWINGS

The teachings of the present principles can be readily understood by considering the following detailed description in conjunction with the accompanying drawings, in which:

FIG. 1 depicts a schematic diagram of two digital cinema packages for two versions of a movie as provided in the prior art;

FIG. 2 depicts a schematic diagram of two digital cinema packages for two versions of a movie according to one embodiment of the present principles, in which only one package contains heavy assets;

FIG. 3 is a schematic diagram of two digital cinema packages for two versions of a movie according to another embodiment of the present principles, in which only one package contains heavy assets and another package contains a subtitle track file;

FIG. 4 is a schematic diagram of two digital cinema packages for two versions of a movie according to yet another embodiment of the present principles, in which only one package contains heavy assets and another package contains a sound track file for a different language;

FIG. 5 depicts an exemplary process, according to one embodiment of the present principles, to create and distribute two versions of a movie, such as those depicted in FIGS. 2-4; and

FIG. 6 is a schematic diagram illustrating a system suitable for implementing a process according to the present principles.

To facilitate understanding, identical reference numerals have been used, where possible, to designate identical elements that are common to the figures.

### DETAILED DESCRIPTION

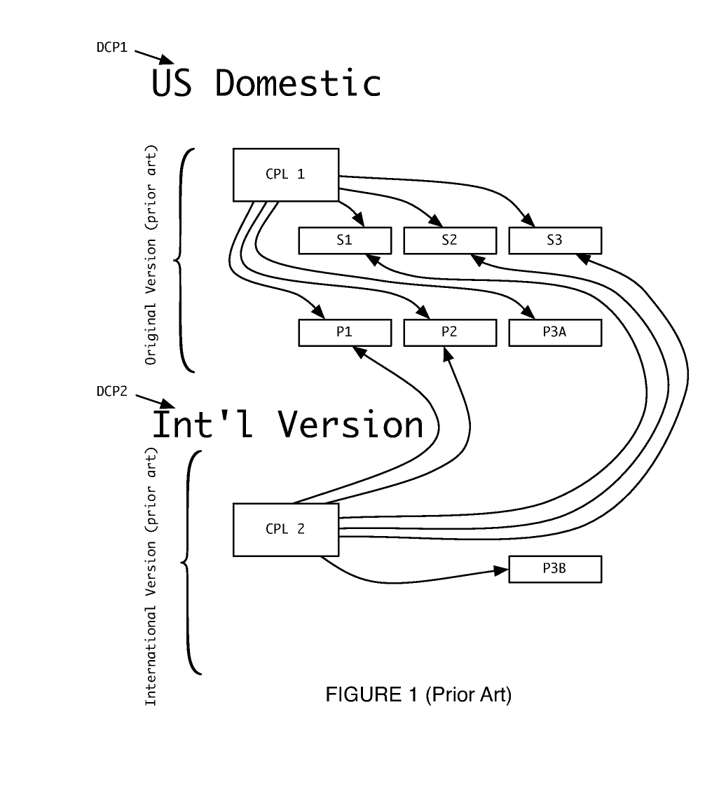

FIG. 1 depicts a block schematic diagram of a first prior art digital cinema package (DCP1), in this example designated as a U.S.-Domestic package, comprising a first CPL (CPL 1) and six asset files: three sound track files (S1, S2, S3) and three picture track files (P1, P2, P3A). Arrows from CPL 1 to each of the six assets are meant to show that CPL 1 is referencing these assets. Those skilled in the art will understand that CPL 1 will include, in this example, three reels, with the first reel referencing both S1 and P1 to provide sound and picture in synchronization for a first portion of the movie, a second reel referencing S2 and P2 for the second portion, and a third reel referencing S3 and P3. Thus, in these figures, reels are implied, but not explicitly shown. In some embodiments, additional track files (e.g., closed captions) might be also provided, and are well-understood. In this example, this is the original version (OV) package.

In FIG. 1 and subsequent figures, the PKLs and the asset maps for the DCPs are not shown, though both are conventional and known to one skilled in the art, in which the PKLs identify the CPL and the asset files of the same, corresponding package by UUID, and the corresponding asset maps associate (index) the UUIDs to specific files contained in that package.

A second DCP (DCP2), also of the prior art, is shown in FIG. 1 as a supplemental package, in this example designated as the international version. The DCP2 includes a second CPL (CPL 2), which references a replacement picture track file (P3B), in addition to five track files (S1, S2, S3, P1, P2) from the original version DCP (DCP1). In CPL 2, the first and second reels are the same, referencing S1 and P1 in the first reel, and S2 and P2 in the second reel. The third reel references the new picture track file P3B, and the original sound file S3. In some embodiments, a new sound file (not shown) can be provided for use in the third reel.

Embodiments of the present invention provide a reliable method for creating and distributing different versions of a movie. A first digital cinema package (DCP) contains a first composition playlist (CPL) for a first version of a movie, along with the corresponding assets, in which at least one asset (e.g., a picture track file or other heavy asset) is a “composite” asset, that is, one comprising a first portion used by at least the first CPL and a second portion not used by any CPL in the first DCP, but intended for use in a second version of the movie. The second portion is different or distinct from the first portion. Once created, this first DCP is distributed and when ingested by a player, the entirety of the composite asset (both the first and second portions) is loaded.

A second CPL, corresponding to (or defining) the second version of the movie, is created and distributed separately, but without duplicating any of the composite asset. Thus, the second portion is distributed in the first DCP, and though not referenced by the first CPL (nor any CPL in the first DCP), it is loaded and retained while the first CPL is retained. Accordingly, when the second CPL is received and ingested, the second portion of the composite asset is already available. The small size of the second CPL makes its distribution both fast and economical. In some cases, the second CPL is provided in a second DCP. The second DCP may further include additional assets, e.g., subtitle track files and/or alternative sound track files, as needed for the second version and not provided in the first DCP. These various features are further discussed below.

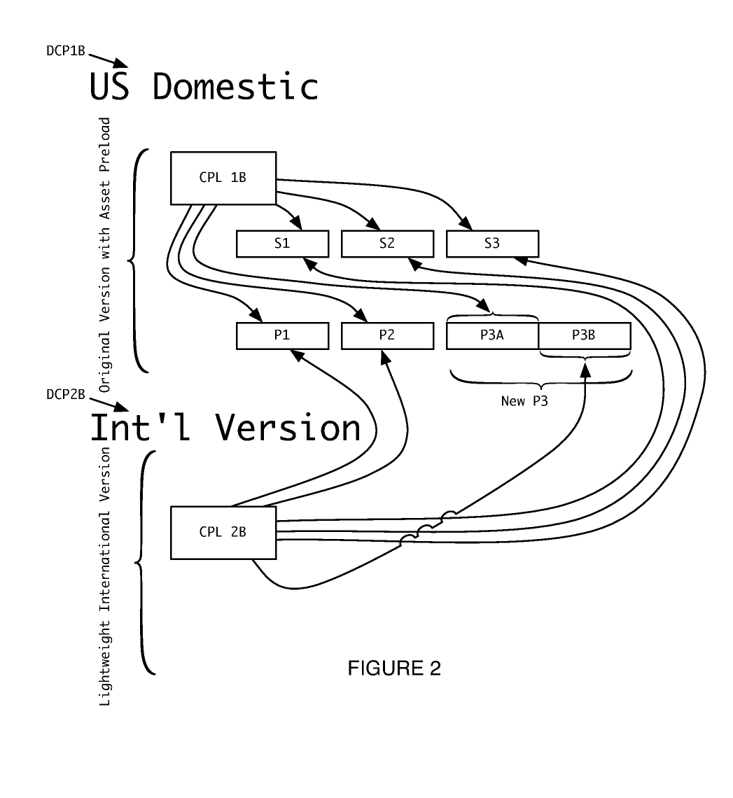

FIG. 2 shows two digital cinema packages according to one embodiment of the present principles. The first package DCP1B is an original version (again, by way of example, a U.S. Domestic version) comprising a first CPL (CPL 1B), and six asset files (S1, S2, S3, P1, P2, P3). P3 is a new picture asset file that includes both the picture assets in P3A and those in P3B. CPL 1B has three reels, in which the first reel references S1 and P1, the second reel references S2 and P2, and the third reel references S3 and P3. In CPL 1B, the reference to P3 further identifies the portion corresponding to the picture assets of P3A.

The ability to identify a portion of an asset track file is provided in CPLs by specifying the optional parameters of “EntryPoint” and “Duration”, the former specifying at which frame (or ‘edit unit’ as they are formally called) within the identified asset track file the reel is to begin, while the latter specifies the number of frames (or “edit units”) of the asset which are to be played within the reel. When “EntryPoint” is omitted, playout of the reel starts at the beginning of the asset file, and when “Duration” is omitted, playout of the reel ends at the end of the asset file. Thus, if neither is specified, the entirety of the asset track file will be played when the reel is to play.

When CPL 1B is ingested by digital cinema equipment, the six asset files S1, S2, S3, P1, P2, and P3 will also be ingested. During playout of CPL 1B, the first and second reels will play as normal, but the playout of the third reel will play S3 in synchronization with the portion of P3 that corresponds to P3A. Thus, the playout of CPL 1B will appear to be exactly like the playout of CPL 1 of FIG. 1.

Upon ingesting CPL 1B, the portion of the asset corresponding to P3B will have been necessarily ingested, and will further accompany CPL 1B in subsequent transfers, including side-to-side transfers. For this reason, the original version package of FIG. 2 may be called an “original version with asset preload”.

In FIG. 2, the supplemental digital cinema package DCP2B (again, an international version in this example) includes a second CPL (CPL 2B), and in this embodiment, no assets. As mentioned above, the PKL and asset map are not shown. CPL 2B has three reels, the first referencing Si and Pl, the second referencing S2 and P2, and the third referencing S3 and P3. In this case, the reference to P3 further identifies the portion corresponding to the picture assets of P3B, again using the “EntryPoint” and “Duration” parameters as needed. Since this supplemental package has no asset files, it is considered a “lightweight” package.

In some embodiments of digital cinema equipment, a bare CPL can be ingested, i.e., without being enclosed in a DCP, and with no asset map and no PKL. This is possible because the information provided in the asset map and PKL can be derived by exhaustive examination of the CPL and all the assets (if they can be found) to which the CPL refers (though the CPL refers to them by UUID). Some digital cinema equipment, upon ingesting a DCP, maintains an index of content (i.e., asset track files) by UUID, so that later, a new CPL can be ingested and the referenced asset track files identified without need for a PKL or asset map.

Thus, in some embodiments, the “lightweight distribution” may include only CPL 2B, with no PKL and no asset map. Even with the PKL and asset map, the supplemental DCP of FIG. 2 is still considered “lightweight”.

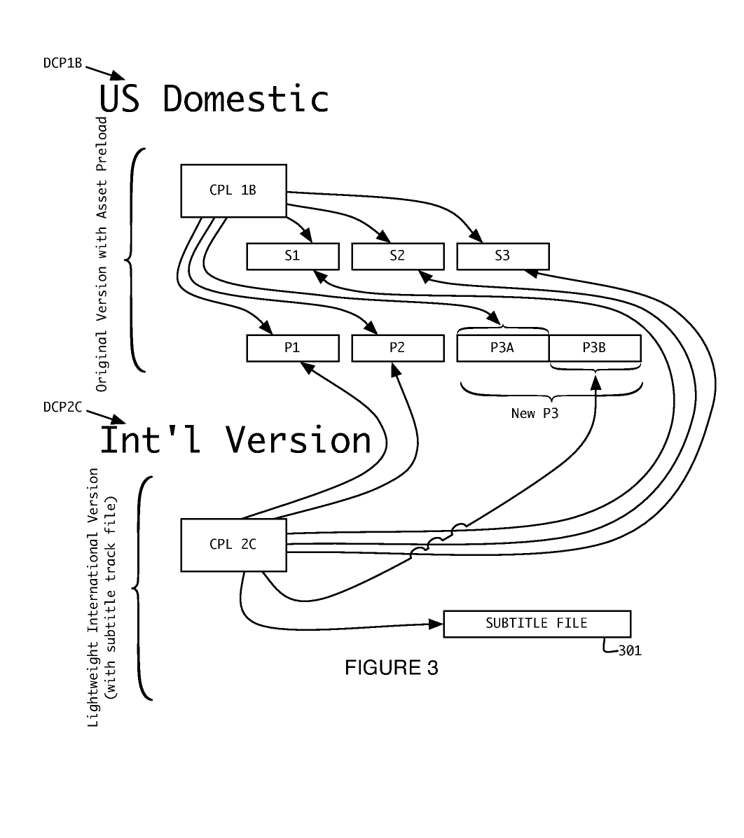

FIG. 3 shows an alternative embodiment of the lightweight supplemental package DCP2C, in which CPL 2C further references a subtitle track file 301. The subtitle track file 301 may be a single track file under the Interop format, or in a SMPTE format DCP, would be split into three subtitle track files, one per reel (not shown). During playout, CPL 2C would show the same presentation as CPL 2 or CPL 2B of FIG. 2, but with the addition of the subtitles from the subtitle track file 301 (or subtitle track files, if packaged according to the SMPTE standards).

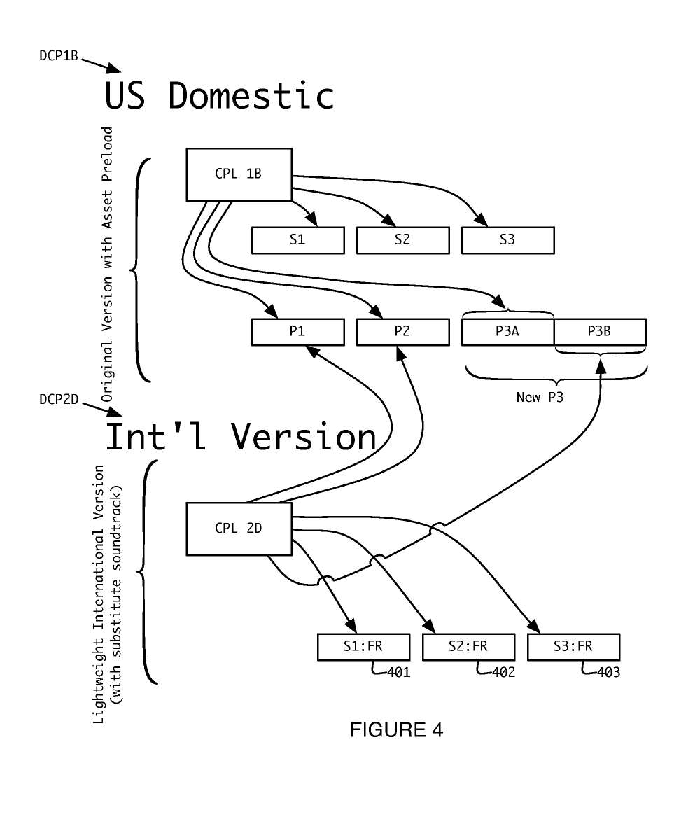

FIG. 4 shows another embodiment of the present principles, which is still a lighter weight distribution than those of FIG. 1, because of the reduced asset file size. The supplemental digital cinema package DCP2D (e.g., the international version) includes different sound track files, in this example having the language of the primary dialog in

French. Here, with CPL 2D, the first reel plays picture track file P1 with a sound track file S1:FR 401 (which corresponds to the first sound track file, but with French dialog dubbed in, instead of the original language), and the second reel plays picture track file P2 with a second sound track file with French dialog S2:FR 402. Lastly, the third reel plays picture track file P3, but only the portion corresponding to the picture assets of P3B, and a third sound track file with French dialog S3:FR 403.

Note that in each of FIGS. 2-4, the same DCP1B is presented as the US domestic version and includes the same CPL 1B. Thus, the same original version DCP1B can be used as the basis for any of DCP2B-D, with corresponding different international version CPLs (CPL 2B-D).

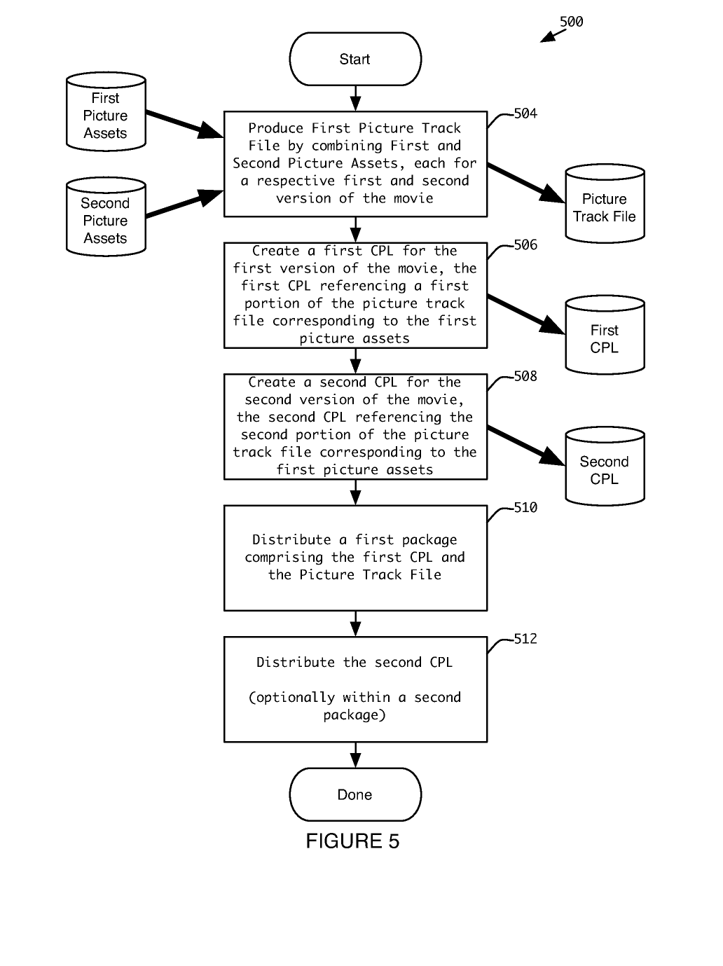

FIG. 5 shows a flowchart for a digital cinema package creation and distribution process 500 according to one embodiment of the present principles. Process 500 is used for distributing two composition playlists, a first one having assets with large file sizes (e.g., picture assets) and a second one with assets having file sizes considerably smaller than the picture assets of the first composition playlist. At the start of this process, assets necessary for the first composition playlist are made available for use in forming one or more picture track files.

At step 504 of the process, a first picture track file is produced (e.g., P3 in FIG. 2) by combining first picture assets (e.g., those used to build picture track file P3A such as TIFF files, or the picture track file P3A itself), and second picture assets (e.g., those used to build picture track file P3B, or the picture track file P3B itself). The result of this step 504 is a composite picture track file comprising a first portion and a second portion, the first portion corresponding to the first picture assets, and the second portion corresponding to the second picture assets. In one embodiment, at least one of the first picture asset (P3A) and the second picture asset (P3B) is obtained from a second picture track file that is different from the first picture track file.

At step 506, a first CPL (e.g., CPL 1B) is created, which includes a reference to a first portion of the first picture track file, but no reference to a second portion.

At step 508, a second CPL (e.g., CPL 2B) is created, which includes a reference to at least the second portion of the first picture track file. Depending on the specific situations, the second CPL may, or may not, include any reference to the first portion of the first picture track file. For example, if an international version merely adds additional material, but does not exclude anything from the original version (this scenario is not shown in FIGS. 1-4), the second CPL may include references corresponding to some or all of the first picture assets in the picture track file.

At step 510, a first digital cinema package that includes the first CPL (e.g., CPL 1B) and the picture track file (e.g., P3) is distributed. The presence of the picture track files (e.g., P1-P3) makes this a heavyweight distribution. Ideally, this distribution is done using the most economical distribution available (e.g., shipping a hard drive, or using a satellite link to download the package),and with sufficient lead time so that if there is any transfer error, another hard drive can still be sent.

At step 512, the second CPL (e.g., CPL 2B-D) is distributed. This may occur by distributing the bare CPL (as could work for CPL 2B in FIG. 2, for some instances of digital cinema equipment), or by distributing a supplemental DCP2B-D comprising corresponding CPL 2B-D (as shown in FIG. 2-4). In the case of the embodiments of FIGS. 3-4, the supplemental DCP2C-D comprising corresponding CPL 2C-D will also include additional asset track files, e.g., the subtitle track file of FIG. 3, or the replacement sound track files S1:FR (401), S2:FR (402), and S3:FR (403), of FIG. 4, as shown.

In some cases, the supplemental DCP may include additional picture track files (not shown in FIGS. 2-4) that are not available in the first CPL, which the second CPL may also reference. These additional picture track files are preferably kept to a minimum or relatively small size so as to retain the benefits of a “lightweight” distribution.

Furthermore, although the “heavy” assets are identified as the picture track files in the above examples, one or more features of the present principles can similarly be applied to audio assets. For example, by including one or more audio assets with larger file sizes in the first composition playlist (or first DCP), one can also advantageously reduce the size of the subsequent distribution.

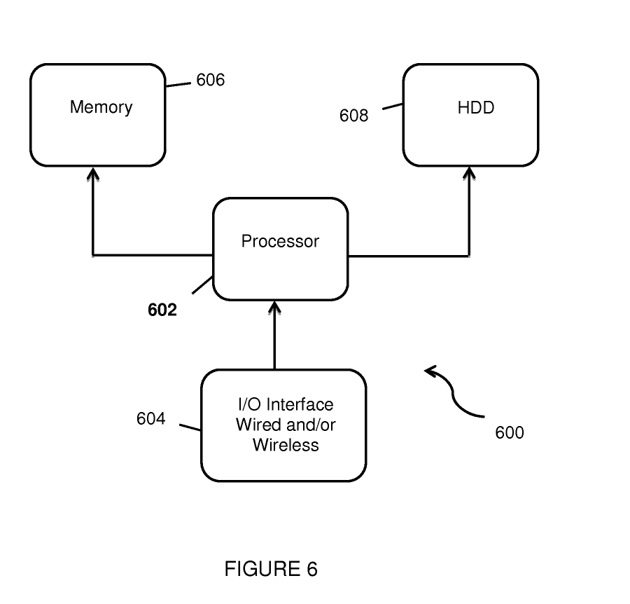

FIG. 6 shows a block diagram of a system 600 that suitable for use in distributing digital cinema assets according to one or more embodiments of the present principles. The system 600 includes at least one processor 602, one or more memories 606 and/or storage devices 608 such as hard disk drive, and at least one I/O interface 604. Various assets, files and/or digital cinema packages can be stored in at least one of memory 606 and storage device 608. The processor 602, which is operatively coupled to at least one of memory 606 and storage device 608 for storing and/or retrieving assets, files and digital cinema packages, is configured for executing program instructions (e.g., stored in non-transient computer-readable medium) for implementing one or more method steps according to the present principles. The I/O interface 604, which can be wired or wireless, allows the system 600 to communicate with other computers or servers, including cloud-based computing or storage servers.

In some cases, the storage device 608 may be a portable device, i.e., removable from system 600, as a mechanism by which digital cinema content may be distributed. This is particularly well suited for “heavy” digital cinema packages. “Lightweight” packages from memory 606 or storage device 608 can be easily distributed through I/O interface 604. Depending upon the bandwidth (or time) available, I/O interface 604 may be suitable for “heavy” digital cinema packages as well.

Furthermore, some or all of the first and second picture assets, picture track file, first and second compositions, can be recorded or stored on a non-transient computer or machine readable medium for use with one or more embodiments of the present principles.

The various embodiments disclosed herein can be implemented as hardware, firmware, software executed by a processor, controller or machine, or any combination thereof. Moreover, the software is preferably implemented as an application program tangibly embodied on a program storage unit or non-transitory computer readable medium (e.g., hard drive, removable storage, read-only memory, random accessible memory, among others), to be uploaded to, and executed by, a machine comprising any suitable architecture. In one embodiment, program instructions are stored in the computer readable medium such that, when executed by one or more processors, will cause a method of the present invention to be implemented as discussed above.

The foregoing describes a technique for creating and distributing multiple versions of a movie for use in digital cinema equipment. While the foregoing is directed to various embodiments of the present principles, other embodiments of the invention may be devised without departing from the basic scope thereof. For example, one or more features described in the examples above can be modified, omitted and/or used in different combinations. Thus, the appropriate scope of the invention is to be determined according to the claims that follow.

1. A method for movie distribution, comprising:
a) distributing a first digital cinema package (DCP1B) comprising a first composition packing list (CPL) and a picture track file (P3); the picture track file having a first portion and a distinct second portion corresponding to respective first and second picture assets (P3A, P3B) that are associated with respective first and second versions of a movie;
wherein the first CPL references the first portion but not the second portion of the picture track file (P3); and
b) distributing a second CPL (CPL2B) without the second picture asset, wherein the second CPL references at least the second portion of the picture track file (P3);
wherein the first CPL corresponds to a first version of the movie, and the second CPL corresponds to the second version of the movie.

2. The method of claim 1, wherein the second CPL is distributed as a part of a second digital cinema package (DCP2B).

3. The method of claim 2, wherein the second digital cinema package (DCP2C) further comprises a subtitle track file (301).

4. The method of claim 3, wherein the second CPL (CPL2C) further references the subtitle track file.

5. The method of claim 1, wherein the second CPL does not reference the first portion.

6. The method according to claim 2, wherein the second digital cinema package (DCP2D) further comprises an audio track file (401) referenced by the second CPL (CPL2D).

7. The method of claim 1, wherein at least one of the first picture asset (P3A) and the second picture asset (P3B) is obtained from a second picture track file that is different from the first picture track file.

8. A digital cinema distribution, comprising:
a first digital cinema package (DCP1B) that includes:
a first picture track file (P3) having a first portion corresponding to a first picture asset (P3A) and a distinct second portion corresponding to a second picture asset (P3B), wherein the first picture asset (P3A) is associated with a first version of a movie and the second picture asset (P3B) is associated with a second version of the movie; and
a first composition packing list (CPL) that references the first portion of the first picture track file (P3) but not the second portion; and
a second CPL (CPL2B) that references at least the second portion of the first picture track file (P3), wherein the second CPL does not include the second picture asset; and
wherein the first CPL corresponds to a first version of the movie, and the second CPL corresponds to the second version of the movie.

9. The digital cinema asset of claim 8, wherein the second CPL is distributed as a part of a second digital cinema package (DCP2B).

10. The digital cinema asset of claim 9, wherein the second digital cinema package (DCP2C) further comprises a subtitle track file (301).

11. The digital cinema asset of claim 10, wherein the second CPL (CPL2C) further references the subtitle track file.

12. The digital cinema asset of claim 8, wherein the second CPL does not reference the first portion.

13. The digital cinema asset according to claim 9, wherein the second digital cinema package (DCP2D) further comprises an audio track file (401) referenced by the second CPL (CPL2D).

14. The digital cinema asset of claim 8, wherein at least one of the first picture asset (P3A) and the second picture asset (P3B) is obtained from a second picture track file that is different from the first picture track file.
